(19) United States
(12) Patent Application Publication
(10) Pub. No.: US 2025/0251340 A1
(43) Pub. Date: Aug. 7, 2025

(54) HANDHELD SNAPSHOT MULTISPECTRAL IMAGING CROP GROWTH SENSING DEVICE

(71) Applicant: NANJING AGRICULTURAL UNIVERSITY, Nanjing (CN)

(72) Inventors: Yan ZHU, Nanjing (CN); Yongxian WANG, Nanjing (CN); Dong ZHOU, Nanjing (CN); Weixing CAO, Nanjing (CN); Xia YAO, Nanjing (CN); Xiaohu ZHANG, Nanjing (CN); Hengbiao ZHENG, Nanjing (CN); Yu ZHANG, Nanjing (CN)

(73) Assignee: NANJING AGRICULTURAL UNIVERSITY, Nanjing (CN)

(21) Appl. No.: 18/952,354

(22) Filed: Nov. 19, 2024

(30) Foreign Application Priority Data
Feb. 6, 2024 (CN) 202410168979.7

(51) Int. Cl. G01N 21/31; G01N 21/84; G06F 3/044; H04N 23/11; H04N 23/13; H04N 23/63; H04N 23/695; H04N 23/76

(52) U.S. Cl. CPC G01N 21/31; G01N 21/84; H04N 23/11; H04N 23/13; H04N 23/631; H04N 23/695; H04N 23/76; G01N 2021/8466; G06F 3/044

(57) ABSTRACT

A handheld snapshot multispectral imaging crop growth sensing device, including an imaging objective lens, a spectral imaging module, a main control module, a power supply module, a stability maintenance gimbal, a Red-Green-Blue (RGB) imaging module, a ranging sensor, a handheld rod, a control display, and a housing. The imaging objective lens is arranged below the housing. The spectral imaging module is arranged above the imaging objective lens. The main control module is arranged above the spectral imaging module. The stability maintenance gimbal is arranged above the housing. The stability maintenance gimbal is connected to the handheld rod. The RGB imaging module and the ranging sensor are arranged below the housing. The control display is fastened to the handheld rod. The power supply module supplies power to various modules.

### TECHNICAL FIELD

The present disclosure relates to the field of intelligent agriculture, and in particular, to a handheld snapshot multispectral imaging crop growth sensing device.

### BACKGROUND

Real-time perception of crop growth characteristics plays an important role in accurate diagnosis of crop growth, field intelligent management, and high-quality high-efficiency ecological safety production of crops. Spectral imaging technology interprets the crop growth characteristics by obtaining crop spectrum and image information, and has technical advantage of image and spectrum integration. As an implementation carrier of a spectrum technology, a spectral imaging sensor directly detects and obtains the crop spectrum and image information, and becomes a powerful tool for monitoring and parsing the crop growth characteristics.

Handheld spectral imaging equipment has significant advantages in an aspect of estimating crop growth characteristic information at field scale. The handheld spectral imaging equipment has multiple bands and rich data volume. However, most of the equipment images in a manner of dispersive spectroscopy. Instrument volume is large, data processing is complex, and crop growth information cannot be directly interpreted. Patents 201610161160.3, 202111373941.6, 201711416151.5, and 202110520824.1 respectively disclose a narrow-band multispectral camera array imaging device, a wide-viewing angle multispectral imaging crop growth sensing device, a narrow-band multispectral camera array imaging device, and a multispectral and optical camera sensor device for crop growth monitoring. All of the above devices carry out operations of collecting crop image and spectrum information through an optical-mechanical structure of “multiple lenses+multiple filters+multiple detectors”. However, an application of this of device the near ground is affected by a serious view field difference between lenses, and it is difficult to carry out registration and fusion of image and spectrum information in real time. Moreover, it is difficult to ensure an optimal monitoring height and angle and ensure accuracy of interpreted crop growth characteristic information due to different crop growth characteristics and errors caused by manual operations.

### SUMMARY

An objective of the present disclosure is to provide a handheld snapshot multispectral imaging crop growth sensing device to overcome disadvantages in above BACKGROUND. The device achieves collection of crop image and spectrum information in four bands and four channels through pixel level coated filters and a detector, reduces complexity of an optical-mechanical structure, achieves accurate control of a pitch angle and a height through a three-axis gimbal and a laser ranging sensor, avoids impact on inversion accuracy of crop growth characteristics due to observation angle and height changes, and achieves collection, processing, and interpreting of the image and spectrum information and real-time display of crop growth multi-characteristic information by combining a main control module and a control display.

To achieve the above objective, a technical solution adopted by the present disclosure is that: a handheld snapshot multispectral imaging crop growth sensing device includes an imaging objective lens, a spectral imaging module, a main control module, a power supply module, a stability maintenance gimbal, a Red-Green-Blue (RGB) imaging module, a ranging sensor, a handheld rod, a control display, and a housing. The imaging objective lens is arranged below the housing. The spectral imaging module is arranged above the imaging objective lens. The main control module is arranged above the spectral imaging module. The stability maintenance gimbal is arranged above the housing. The stability maintenance gimbal is connected to the handheld rod. The RGB imaging module and the ranging sensor are arranged below the housing. The control display is fastened to the handheld rod. The power supply module supplies power to various modules.

Further, the imaging objective lens is a C interface lens, and has a focal length of 12 mm, a field of view of 67°, a minimum imaging distance greater than 10 cm, and an imaging band range of 400 to 1000 nm. The C interface lens is fixedly mounted below the housing through a light hole of the housing.

Further, the spectral imaging module includes pixel level coated filters and a detector. The pixel level coated filters are mounted at a light input end of the detector. Central bands of the pixel level coated filters are respectively 644 nm, 716 nm, 737 nm, and 813 nm, a bandwidth is 10 nm, a dimension of a region corresponding to each band is 11 μm×11 μm, a peak transmittance is greater than 95%, and an out-of-band cutoff is less than 0.5%.

Further, the stability maintenance gimbal is a three-axis gimbal; an inner surface of a shaft arm of the three-axis gimbal is connected to the housing through a sleeve; an outer surface of the shaft arm of the three-axis gimbal is fixedly connected to the housing through screws; and the shaft arm may provide an adjustment of a pitch angle from −60° to +60°.

Further, an auxiliary imaging module is an RGB imaging module. The RGB imaging module is fixed below the housing through studs, and has 5 million pixels, a focal length of 3.5 mm, and a field of view of 68°; the ranging sensor is a laser ranging sensor; and the laser ranging sensor is fixed below the housing through studs and has a measurement range of 4 to 400 cm and measurement accuracy of ±20 mm.

Further, the main control module is an NVIDIA JETSON TX2 core plate. The NVIDIA JETSON TX2 core plate is fixed to an interior of the housing through screws, and is connected to the spectral imaging module, the auxiliary imaging module, and the ranging sensor in a wired manner to achieve collecting, processing, and interpreting of the crop image and spectrum information; and a front panel, a middle housing, and a rear panel of the housing are fixedly connected to one another through fixing columns and screws.

Further, the control display is a capacitive touch display. The capacitive touch display is connected to the NVIDIA JETSON TX2 core plate in a wired manner to transmit a control command and to receive and display crop growth multi-characteristic parameter information, and communicates with the three-axis gimbal in a wireless manner to control a pitch angle of the three-axis gimbal. The capacitive touch display is fixed to one side of the handheld rod in a clamping manner, which can achieve 360°-rotation adjustment.

Further, the power supply module includes a first lithium battery, a second lithium battery, a first button switch, and a second button switch. The first lithium battery and the first button switch supply power to and control the three-axis gimbal; the second lithium battery and the second button switch supply power to and control the NVIDIA JETSON TX2 core plate; and the NVIDIA JETSON TX2 core plate supplies power to the spectral imaging module, the RGB imaging module, the laser ranging sensor, and the control display in a wired manner.

Further, the handheld rod includes an upper rod, a lower rod, and a clamping device. The upper rod is fixedly connected to the three-axis gimbal through screws. The lower rod of the handheld rod is a telescopic rod. The upper rod is fastened to the lower rod through threaded grooves in a lower part of the upper rod and threads in an upper part of the lower rod. The clamping device is fastened to the handheld rod through a ball-and-socket hinge style mounting seat.

The control display (10) is a capacitive touchscreen. The capacitive touchscreen is combined with a main controlmodule NVIDIA JETSON TX2 for controlling the multispectral imaging sensing device to complete collecting, parsing, displaying, and storing of a crop multispectral image, controlling accurate adjustment of an angle of the three-axis gimbal, and displaying a position angle and a height of a multispectral imaging sensing device in real time. Meanwhile, the main control module controls a Beidou and Global Positioning System (GPS)dual-mode positioning module to obtain the geographical position information, so that a spatial distribution map of regional crop growth characteristics can be generated by combining the crop growth characteristics at field scale.

Preferably, the main control module is connected to the spectral imaging module, the RGB imaging module, and the ranging sensor in a wired manner to achieve collecting and processing of crop image and spectrum information. A crop growth monitoring model is embedded into the main control module to achieve interpreting, storing, and displaying of the crop growth characteristics.

Specifically, operation steps of the device are as follows:
S1: starting the multispectral imaging sensing device by using the button switch, placing the multispectral imaging sensing device above a crop canopy through a handheld device, observing a distance measured by the ranging sensor through the capacitive touchscreen, taking the distance as a fixed distance for subsequent collection work, then controlling the three-axis gimbal through the capacitive touchscreen, adjusting the multispectral imaging sensing device to a suitable observation angle by using the three-axis gimbal, and taking the angle as a fixed angle for the subsequent collection work;
S2: clicking an automatic exposure button of the multispectral imaging sensing device by using the capacitive touchscreen, recording an exposure time, placing a diffuse reflection calibration plate with a reflectivity of 99% below a lens of the multispectral imaging sensing device, clicking a calibration image collection button through the capacitive touchscreen, storing a calibration plate image to the main control module, clicking a dark background collection button through the capacitive touchscreen after covering the lens through a lens cover, storing a dark background image to the main control module, and performing radiation correction on a subsequently captured crop multispectral image through the following formula:

$$R = \frac{{D}_{c} - {D}_{d}}{{D}_{w} - {D}_{d}}$$

where D_{c} is a crop image, D_{w} is a calibration plate image, and D_{d} is a dark background image;
S3: writing geographical position information of the multispectral imaging sensing device to a txt file and storing through the main control module while collecting the crop image, controlling, through the main control module, the RGB imaging module to collect and store a crop RGB image, then reconstructing the crop image into a crop multispectral image by using a bilinear interpolation algorithm, and naming and storing according to a collection time;
S4: achieving real-time interpreting of multiple growth characteristics through a rice and wheat growth characteristic estimation model embedded into the main control module, specific calculation formulas being as follows:
calculating an aboveground biomass of wheat through the following formula:

$${Y}_{1} = 0.303 \times {e}^{8.181 \times NDRE}$$

where a calculation formula for an NDRE is as follows:

$$NDRE = \frac{{R}_{813} - {R}_{716}}{{R}_{813} + {R}_{716}}$$

where R₈₁₃ is a spectral image in the band of 813 nm, R₇₁₆ is a spectral image in the band of 716 nm, and Y₁ represents the aboveground biomass of wheat;
calculating a leaf area index of wheat through the following formula:

$${Y}_{2} = 20.687 \times {RESAVI}^{1.352}$$

where a calculation formula of a RESAVI is as follows:

$$RESAVI = 1.5 \times \frac{{R}_{813} - {R}_{716}}{{R}_{813} + {R}_{716} + 0.5}$$

where R₈₁₃ is a spectral image in the band of 813 nm, R₇₁₆ is a spectral image in the band of 716 nm, and Y₂ represents the leaf area index of wheat;
calculating an aboveground biomass of rice through the following formula:

$${Y}_{3} = 3.560 \times {e}^{13.038 \times NDRE}$$

where a calculation formula for an NDRE is as follows:

$$NDRE = \frac{{R}_{813} - {R}_{737}}{{R}_{813} + {R}_{737}}$$

where R₈₁₃ is a spectral image in the band of 813 nm, R₇₃₇ is a spectral image in the band of 737 nm, and Y₃ represents the aboveground biomass of rice; and calculating a leaf area index of rice through the following formula:

$${Y}_{4} = 0.632 \times {e}^{35.423 \times RESAVI}$$

where a calculation formula of a RESAVI is as follows:

$$RESAVI = 1.5 \times \frac{{R}_{813} - {R}_{737}}{{R}_{813} + {R}_{737} + 0.5}$$

where R₈₁₃ is a spectral image in the band of 813 nm, R₇₃₇ is a spectral image in the band of 737 nm, and Y₄ represents the leaf area index of rice; and
S5: integrating the geographical position information and crop growth characteristic information of each field obtained in steps S3 and S4 into a comprehensive dataset; and expanding the crop growth characteristic information of the field to an overall region through steps of spatial correlation, regional scale interpolation, and growth region scale image and visualization presentation to provide information support for agricultural management.

The present disclosure has the beneficial effects that: crop image and spectrum information is obtained in four bands and four channels based on pixel level coated filters, complexity of an optical-mechanical structure is reduced, a multispectral imaging technology based on light splitting of a chip level filter is overcome, accurate control of a pitch angle and a height is achieved through a three-axis gimbal and a laser ranging sensor, a problem of impact on inversion accuracy of crop growth characteristics due to observation angle and height changes is solved, and collection, processing, and interpreting of the crop image and spectrum information and real-time lossless obtaining and visual display of crop growth multi-characteristic information are achieved by the device.

Additional aspects and advantages of the present disclosure will be set forth in part in the following description, and some will become apparent from the following description, or will be understood by practice of the present disclosure.

### BRIEF DESCRIPTION OF THE DRAWINGS

FIG. 1 is a schematic structural diagram of an overall handheld snapshot multispectral imaging crop growth sensing device.

FIG. 2 is a schematic structural diagram of mounting of a spectral imaging system.

FIG. 3 is a schematic diagram of hardware connection of a handheld snapshot multispectral imaging crop growth sensing device.

FIG. 4 shows schematic diagrams corresponding to bands of pixel level coated filters.

FIG. 5 shows transmittance curves of pixel level coated filters.

Reference signs in the drawings: 1—imaging objective lens, 2—spectral imaging module, 21—pixel level coated filter, 22—detector, 3—housing, 31—front panel, 32—middle housing, 33—rear panel, 4—three-axis gimbal, 5—microcomputer, 6—power supply module, 61—first lithium battery, 62—first button switch, 63—second lithium battery, 64—second button switch, 7—RGB imaging module, 8—ranging sensor, 9—handheld rod, 91—clamping device, 92—lower rod, 93—upper rod, 10—control display.

### DETAILED DESCRIPTION

The present disclosure will be described in detail below in combination with drawings and specific embodiments.

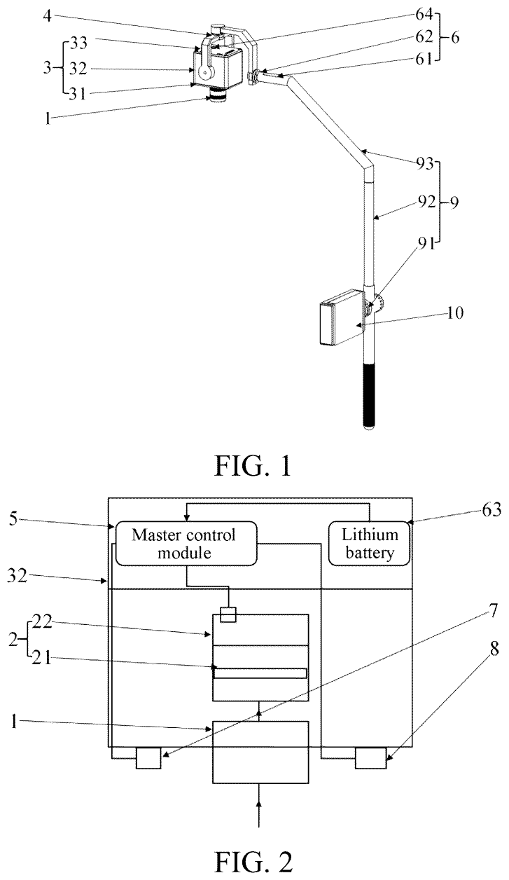

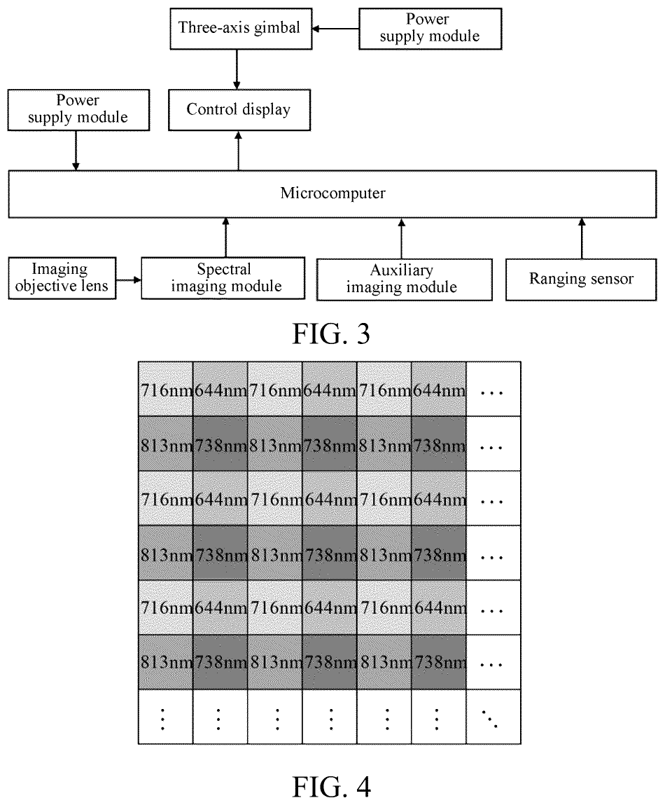

As shown in FIG. 1 to FIG. 3, a handheld snapshot multispectral imaging crop growth sensing device includes an imaging objective lens 1, a spectral imaging module 2, a main control module 5, a power supply module 6, a stability maintenance gimbal 4, an RGB imaging module 7, a ranging sensor 8, a handheld rod 9, a control display 10, and a housing 3. The imaging objective lens 1 is arranged below the housing 3, the spectral imaging module 2 is arranged above the imaging objective lens 1, the main control module 5 is arranged above the spectral imaging module 2, the stability maintenance gimbal 4 is arranged above the housing 3, the stability maintenance gimbal 4 is connected to the handheld rod 9, the RGB imaging module 7 and the ranging sensor 8 are arranged below the housing 3, the control display 10 is fastened to the handheld rod 9, and the power supply module 6 supplies power to various modules.

In the present disclosure, a C interface lens 1 has a focal length of 12 mm, a field of view of 67°, a minimum imaging distance greater than 10 cm, and an imaging band range of 400 to 1000 nm. The C interface lens 1 is fixedly mounted below the housing 3 through a light hole of the housing 3, which can obtain crop image and spectrum information with a wide field of view at close distance.

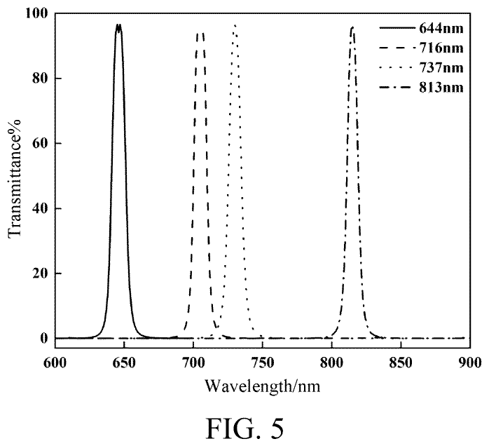

In the present disclosure, as shown in FIG. 2, FIG. 4, and FIG. 5, pixel level coated filters 21 are mounted at a light input end of a detector 22. Central bands of the pixel level coated filters 21 are respectively 644 nm, 716 nm, 737 nm, and 813 nm, a bandwidth is 10 nm, a dimension of a region corresponding to each band is 11 μm×11 μm, a peak transmittance is greater than 95%, and an out-of-band cutoff is less than 0.5%. The designed pixel level coated filters 21 ensure spatial uniformity and spectral consistency of spectral channels, and the crop image and spectrum information in four bands can be obtained in a snapshot manner through one exposure.

In the present disclosure, as shown in FIG. 1, an inner surface of a shaft arm of a three-axis gimbal 4 is connected to the housing 3 through a sleeve; an outer surface of the shaft arm of the three-axis gimbal 4 is fixedly connected to the housing 3 through screws; and the shaft arm may provide an adjustment of a pitch angle from −60° to +60°, and can accurately adjust the angle through the control display 10, which achieves accurate collection of the crop image and spectrum information, and is beneficial to ensuring crop growth monitoring accuracy.

In the present disclosure, as shown in FIG. 2, the RGB imaging module 7 is fixed below the housing 3 through studs, and has 5 million pixels, a focal length of 3.5 mm, and a field of view of 68°. The imaging module provides an auxiliary imaging visual angle for crop image and spectrum information collection work, and meanwhile, can provide a crop RGB image with high spatial resolution. A laser ranging sensor 8 is fixed below the housing 3 through studs and has a measurement range of 4 to 400 cm and measurement accuracy of ±20 mm, which is beneficial to ensuring an accuracy collection height.

In the present disclosure, as shown in FIG. 1 to FIG. 3, an NVIDIA JETSON TX2 core plate 5 is fixed to an interior of the housing 3 through screws, and is connected to the spectral imaging module 3, the RGB imaging module 7, and the laser ranging sensor 8 in a wired manner to achieve collecting and processing of the crop image and spectrum information, and finally achieve interpreting, storing, and displaying of crop growth characteristics by combining an embedded crop growth monitoring model. A front panel 31, a middle housing 32, and a rear panel 33 of the housing are fixedly connected to one another through fixing columns and screws.

In the present disclosure, a capacitive touch display 8 is connected to the NVIDIA JETSON series core plate 5 in a wired manner to transmit a control command and to receive and display crop growth multi-characteristic parameter information, and communicates with the three-axis gimbal 4 in a wireless manner to control a pitch angle of the three-axis gimbal 4. The capacitive touch display 8 is fixed to one side of the handheld rod 9 in a clamping manner, which can achieve 360°-rotation adjustment. A requirement on high-accuracy collection of the crop image and spectrum information is met, and meanwhile, a visual human-computer interaction interface can also be provided.

In the present disclosure, a first lithium battery 61 and a first button switch 62 supply power to and control the three-axis gimbal 4; a second lithium battery 63 and a second button switch 64 supply power to and control the NVIDIA JETSON series core plate 5; and the NVIDIA JETSON series core plate 5 supplies power to the spectral imaging module 2, the RGB imaging module 7, the laser ranging sensor 8, and the capacitive touch display 8 in a wired manner.

In the present disclosure, as shown in FIG. 1, an upper rod 93 of the handheld rod 9 is fixedly connected to the three-axis gimbal 4 through screws. A lower rod 92 of the handheld rod is a telescopic rod. The upper rod 93 is fastened to the lower rod 92 through threaded grooves in a lower part of the upper rod 93 and threads in an upper part of the lower rod 92. A clamping device 91 is fastened to the handheld rod 9 through a ball-and-socket hinge style mounting seat.

### Operation Steps of the Device are as Follows:

In S1, the multispectral imaging sensing device is started by using the button switch, the multispectral imaging sensing device is placed above a crop canopy through a handheld device, a distance measured by the ranging sensor is observed through the capacitive touchscreen, the distance is taken as a fixed distance for subsequent collection work, then the three-axis gimbal is controlled through the capacitive touchscreen, the multispectral imaging sensing device is adjusted to a suitable observation angle by using the three-axis gimbal, and the angle is taken as a fixed angle for the subsequent collection work.

In S2, an automatic exposure button of the multispectral imaging sensing device is clicked by using the capacitive touchscreen, an exposure time is recorded, a diffuse reflection calibration plate with a reflectivity of 99% is placed below a lens of the multispectral imaging sensing device, a calibration image collection button is clicked through the capacitive touchscreen, a calibration plate image is stored to the main control module, a dark background collection button is clicked through the capacitive touchscreen after the lens is covered through a lens cover, a dark background image is stored to the main control module, and radiation correction is performed on a subsequently captured crop multispectral image through the following formula:

$$R = \frac{{D}_{c} - {D}_{d}}{{D}_{w} - {D}_{d}}$$

where D_{c} is a crop image, D_{w} is a calibration plate image, and D_{d} is a dark background image.

In S3, geographical position information of the multispectral imaging sensing device is written to a txt file and is stored through the main control module while the crop image is collected, the RGB imaging module is controlled through the main control module to collect and store a crop RGB image, then the crop image is reconstructed into a crop multispectral image by using a bilinear interpolation algorithm, and the crop multispectral image is named and stored according to a collection time.

In S4, real-time interpretation of multiple growth characteristics can be achieved through a rice and wheat growth characteristic estimation model embedded into the main control module. Specific calculation formulas are as follows:
an aboveground biomass of wheat is calculated through the following formula:

$${Y}_{1} = 0.303 \times {e}^{8.181 \times NDRE}$$

where a calculation formula for an NDRE is as follows:

$$NDRE = \frac{{R}_{813} - {R}_{716}}{{R}_{813} + {R}_{716}}$$

where R₈₁₃ is a spectral image in the band of 813 nm, R₇₁₆ is a spectral image in the band of 716 nm, and Y₁ represents the aboveground biomass of wheat;
a leaf area index of wheat is calculated through the following formula:

$${Y}_{2} = 20.687 \times R E {SAVI}^{1.352}$$

where a calculation formula of a RESAVI is as follows:

$$RESAVI = 1.5 \times \frac{{R}_{813} - {R}_{716}}{{R}_{813} + {R}_{716} + 0.5}$$

where R₈₁₃ is a spectral image in the band of 813 nm, R₇₁₆ is a spectral image in the band of 716 nm, and Y₂ represents the leaf area index of wheat;
an aboveground biomass of rice is calculated through the following formula:

$${Y}_{3} = 3.560 \times {e}^{13.038 \times N D R E}$$

where a calculation formula for an NDRE is as follows:

$$NDRE = \frac{{R}_{813} - {R}_{737}}{{R}_{813} + {R}_{737}}$$

where R₈₁₃ is a spectral image in the band of 813 nm, R₇₃₇ is a spectral image in the band of 737 nm, and Y₃ represents the aboveground biomass of rice; and
a leaf area index of rice is calculated through the following formula:

$${Y}_{4} = 0.632 \times {e}^{35.423 \times RESAVI}$$

where a calculation formula of a RESAVI is as follows:

$$RESAVI = 1.5 \times \frac{{R}_{813} - {R}_{737}}{{R}_{813} + {R}_{737} + 0.5}$$

where R₈₁₃ is a spectral image in the band of 813 nm, R₇₃₇ is a spectral image in the band of 737 nm, and Y₄ represents the leaf area index of rice.

In S5, the geographical position information and crop growth characteristic information of each field obtained in steps S3 and S4 are integrated into a comprehensive dataset; and the crop growth characteristic information of the field is expanded to an overall region through steps of spatial correlation, regional scale interpolation, and growth region scale image and visualization presentation to provide information support for agricultural management.

Specific embodiments described herein are merely illustrative examples of spirit of the present disclosure. Those skilled in the technical art of the present disclosure can make various modifications or supplements to the described specific embodiments or replace the described specific embodiments in similar manners, but will not deviate from the spirit of the present disclosure or beyond the scope defined in the appended claims.

1. A handheld snapshot multispectral imaging crop growth sensing device, comprising an imaging objective lens, a spectral imaging module, a main control module, a power supply module, a stability maintenance gimbal, a Red-Green-Blue (RGB) imaging module, a ranging sensor, a handheld rod, a control display, and a housing, wherein the imaging objective lens is arranged below the housing, the spectral imaging module is arranged above the imaging objective lens, the main control module is arranged above the spectral imaging module, the stability maintenance gimbal is arranged above the housing, the stability maintenance gimbal is connected to the handheld rod, the RGB imaging module and the ranging sensor are arranged below the housing, the control is fastened to the handheld rod, and the power supply module supplies power to various modules;
the spectral imaging module comprises pixel level coated filters and a detector; the pixel level coated filters are mounted at a light input end of the detector; central bands of the pixel level coated filters are respectively 644 nm, 716 nm, 737 nm, and 813 nm, a bandwidth is 10 nm, a peak transmittance is greater than 95%, and an out-of-band cutoff is less than 0.5%; the various bands are in one-to-one correspondence with pixels in a periodic arrangement of 2×2 for imaging;
the ranging sensor is a laser ranging sensor and has a measurement range of 4 to 400 cm and measurement accuracy of ±20 mm;
the stability maintenance gimbal is a three-axis gimbal; the power supply module comprises a lithium battery and a button switch; an inner surface of a shaft arm of the three-axis gimbal is connected to a middle housing of the housing through a sleeve; an outer surface of the shaft arm of the three-axis gimbal is fixedly connected to the housing through screws; the three-axis gimbal communicates with the control display of a multispectral imaging sensing device in a wireless communication manner, and achieves accurate adjustment of a pitch angle of the shaft arm from −60° to +60° through the control display; the lithium battery supplies power to the stability maintenance gimbal; the button switch is configured to control the stability maintenance gimbal;
the control display is a capacitive touchscreen; operation steps of the device are as follows:
S1: starting the multispectral imaging sensing device by using the button switch, placing the multispectral imaging sensing device above a crop canopy through a handheld device, observing a distance measured by the ranging sensor through the capacitive touchscreen, taking the distance as a fixed distance for subsequent collection work, then controlling the three-axis gimbal through the capacitive touchscreen, adjusting the multispectral imaging sensing device to a suitable observation angle by using the three-axis gimbal, and taking the angle as a fixed angle for the subsequent collection work;
S2: clicking an automatic exposure button of the multispectral imaging sensing device by using the capacitive touchscreen, recording an exposure time, placing a diffuse reflection calibration plate with a reflectivity of 99% below a lens of the multispectral imaging sensing device, clicking a calibration image collection button through the capacitive touchscreen, storing a calibration plate image to the main control module, clicking a dark background collection button through the capacitive touchscreen after covering the lens through a lens cover, storing a dark background image to the main control module, and performing radiation correction on a subsequently captured crop multispectral image through the following formula:
$$R = \frac{{D}_{c} - {D}_{d}}{{D}_{w} - {D}_{d}}$$
wherein D_{c} is a crop image, D_{w} is a calibration plate image, and D_{d} is a dark background image;
S3: writing geographical position information of the multispectral imaging sensing device to a txt file and storing through the main control module while collecting the crop image, controlling, through the main control module, the RGB imaging module to collect and store a crop RGB image, then reconstructing the crop image into a crop multispectral image by using a bilinear interpolation algorithm, and naming and storing according to a collection time;
S4: achieving real-time interpreting of a plurality of growth characteristics through a rice and wheat growth characteristic estimation model embedded into the main control module, specific calculation formulas being as follows:
calculating an aboveground biomass of wheat through the following formula:
$${Y}_{1} = 0.303 \times {e}^{8.181 \times N D R E}$$
wherein a calculation formula for a Normalized Difference Vegetation Index (NDRE) is as follows:
$$NDRE = \frac{{R}_{813} - {R}_{716}}{{R}_{813} + {R}_{716}}$$
wherein R₈₁₃ is a spectral image in the band of 813 nm, R₇₁₆ is a spectral image in the band of 716 nm, and Y₁ represents the aboveground biomass of wheat;
calculating a leaf area index of wheat through the following formula:
$${Y}_{2} = 20.687 \times R E {SAVI}^{1.352}$$
wherein a calculation formula of a Red Edge Soil Adjusted Vegetation Index (RESAVI) is as follows:
$$RESAVI = 1.5 \times \frac{{R}_{813} - {R}_{716}}{{R}_{813} + {R}_{716} + 0.5}$$
wherein R₈₁₃ is a spectral image in the band of 813 nm, R₇₁₆ is a spectral image in the band of 716 nm, and Y₂ represents the leaf area index of wheat;
calculating an aboveground biomass of rice through the following formula:
$${Y}_{3} = 3.560 \times {e}^{13.038 \times N D R E}$$
wherein a calculation formula for an NDRE is as follows:
$$NDRE = \frac{{R}_{813} - {R}_{737}}{{R}_{813} + {R}_{737}}$$
wherein R₈₁₃ is a spectral image in the band of 813 nm, R₇₃₇ is a spectral image in the band of 737 nm, and Y₃ represents the aboveground biomass of rice; and
calculating a leaf area index of rice through the following formula:
$${Y}_{4} = 0.632 \times {e}^{35.423 \times RESAVI}$$
wherein a calculation formula of a RESAVI is as follows:
$$RESAVI = 1.5 \times \frac{{R}_{813} - {R}_{737}}{{R}_{813} + {R}_{737} + 0.5}$$
wherein R₈₁₃ is a spectral image in the band of 813 nm, R₇₃₇ is a spectral image in the band of 737 nm, and Y₄ represents the leaf area index of rice; and
S5: integrating the geographical position information and crop growth characteristic information of each field obtained in steps S3 and S4 into a comprehensive dataset; and expanding the crop growth characteristic information of the field to an overall region through steps of spatial correlation, regional scale interpolation, and growth region scale image and visualization presentation to provide information support for agricultural management.

2. The device according to claim 1, wherein the imaging objective lens is a C interface lens, and has a focal length of 12 mm, a field of view of 67°, a minimum imaging distance greater than 10 cm, and an imaging band range of 400 to 1000 nm; and the C interface lens is fixedly mounted below a front panel through a light hole in the front panel of the housing.

3. The device according to claim 1, wherein the RGB imaging module has 5 million pixels, a focal length of 3.5 mm, and a field of view of 68°.

4. The device according to claim 1, wherein the handheld rod comprises an upper rod, a lower rod, and a clamping device; the upper rod is fixedly connected to the three-axis gimbal through screws; the lower rod is a telescopic rod; the upper rod is fastened to the lower rod through threaded grooves in a lower part of the upper rod and threads in an upper part of the lower rod; and the clamping device is fastened to the handheld rod through a ball-and-socket hinge style mounting seat, and 360°-rotation of the control display can be achieved.

5. The device according to claim 1, wherein the control display is a capacitive touchscreen; the capacitive touchscreen is combined with a main control module NVIDIA TX2 for controlling the multispectral imaging sensing device to complete collecting, parsing, displaying, and storing of a crop multispectral image, controlling accurate adjustment of an angle of the three-axis gimbal, and displaying a position angle and a height of a multispectral imaging sensing device in real time; and meanwhile, the main control module controls a Beidou and Global Position System (GPS)dual-mode positioning module to obtain the geographical position information, so that a spatial distribution map of regional crop growth characteristics can be generated by combining the crop growth characteristics at field scale.

6. The device according to claim 1, wherein the main control module is connected to the spectral imaging module, the RGB imaging module, and the ranging sensor in a wired manner to achieve collecting and processing of crop image and spectrum information; and a crop growth monitoring model is embedded into the main control module to achieve interpreting, storing, and displaying of the crop growth characteristics.
